(19) United States
(12) Patent Application Publication
(10) Pub. No.: US 2010/0295673 A1
(43) Pub. Date: Nov. 25, 2010

(54) CLOUD COMPUTING FOR MONITORING AN ABOVE-GROUND OIL PRODUCTION FACILITY

(75) Inventor: Tahir Ahmad, Wichita, KS (US)

Correspondence Address: SCHWEGMAN, LUNDBERG & WOESSNER, P.A., P.O. BOX 2938, MINNEAPOLIS, MN, 55402, US

(73) Assignee: PetroPower LLC, Wichita, KS (US)

(21) Appl. No.: 12/784,586

(22) Filed: May 21, 2010

Related U.S. Application Data
(60) Provisional application No. 61/180,604, filed on May 22, 2009.

(51) Int. Cl. G08B 1/08

(52) U.S. Cl. 340/539.1

(57) ABSTRACT

A system of solar powered sensors wirelessly coupled for remote monitoring using a wide area network. The sensors can be configured for monitoring a parameter associated with an oil well.

### CLAIM OF PRIORITY

This document claims the benefit of priority, under 35 U.S.C. Section 119(e), to Tahir Ahmad, U.S. Provisional Patent Application Ser. No. 61/180,604, entitled “MONITORING FLUID HANDLING IN AN ABOVE-GROUND OIL PRODUCTION FACILITY,” filed on May 22, 2009 (Attorney Docket No. 3039.001PRV), which is hereby incorporated by reference in its entirety.

### BACKGROUND

Systems for monitoring the operation of an oil production facility are inadequate.

### OVERVIEW

The present subject matter includes a wireless system of low power sensors configured for web-based monitoring of an oil production facility.

In one example, the sensors are micro-powered by, for example, solar energy and communicate using a wireless protocol such as ZigBee.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a block diagram according to one example of the present subject matter.

FIG. 2 illustrates a module according to one example.

FIG. 3 illustrates a block diagram showing a system station according to one example.

FIG. 4 illustrates a block diagram showing a system station according to one example.

FIG. 5 illustrates a block diagram of an example of a system.

FIG. 6 illustrates a block diagram of an example of a system.

FIG. 7 illustrates a process flow diagram according to one example.

### DETAILED DESCRIPTION

An example of the present subject matter provides oil well management using web communication and using wireless sensors.

The present subject matter overcomes obstacles associated with wired technology in that resistance to electrical current in a wire communication line is eliminated. Resistance can cause inaccuracy over time and may cause a system to fail. In addition, the labor costs associated with installing a wired sensor are eliminated. Furthermore, costs to repair can be reduced. The present subject matter communicates using digital data and thus allows for complex monitoring systems.

In one example, a sensor is powered by low voltage supplied by a solar cell. The cost savings associated with providing metered electric service to a sensor is eliminated. One example of a sensor is micro powered and operates using solar power.

Equipment and facilities at an oil field can be monitored using wireless sensors coupled in a communication network. The sensors communicate using digital data and are wirelessly coupled, thus eliminating electrical resistance associated with a communication link. In addition, the sensors can be installed in various locations and configured to monitor a wide variety of parameters. For example, the sensors can be located in various environment conditions.

In one example, a single base station can be used to monitor a variety of different types of field-mounted sensors.

In one example, the sensors are battery powered. The battery can be rechargeable using a solar-powered charging system. The battery can have a useful life of, for example, 18 months to five years.

An example of the present subject matter can be used to reduce periodic maintenance costs, reduce labor, improve reliability, and improve production of a well.

A controller coupled to the communication network can be used to perform advanced functions such as networking, control and data collection at same time. For example, a controller can be configured to wirelessly receive rotational speed data for a motor and upon detecting an overspeed condition, the controller can wirelessly send a signal to shut off the motor.

In one example, an oil well can be managed from a remote location using a communication network and without relying on human interaction.

In one example, the communication network supports remote control of an oil well production facility. For example, a computer or a user can generate a command to cause a change in a valve position or adjust a parameter to control the operation of a well facility. A user can login using a laptop or computer from a remote location and monitor and control an oil field production facility. For example, the system can be used to selectively control a motor or a camera.

In one example, a node draws a current of approximately 0.4 mA and operates using one or more batteries. The power supply can include three size AA nickel-metal hydride batteries (abbreviated NiMH) configured for recharging using a solar panel. The batteries can have a useful life of approximately five years before replacement. In one example, the batteries can operate for approximately three months without sunlight. In one example, a node takes a sample every 15 minutes.

The sampling frequency is selected according to various factors and in one example, sampling occurs every hour. The sampling rate can be different than the rate of data reporting. A first controller manages operation of the sensor (e.g., an ultrasonic sensor) and a second controller manages the timing of the system. The controllers have a sleep mode (current draw of 50 uA) and an operating mode (current draw of 3 mA). In one example, a controller sends a signal to turn on an ultrasonic sensor. An ultrasonic sensor can emit a sound wave that travels down to the bottom of the oil tank and bounces back to the ultrasonic sensor and the system determines the total travelling time and converts this to a distance. When turned on, the ultrasonic sensor draws 25 mA of current.

A tank sensor is configured to operate using ten size AA NiMH batteries. The batteries are rechargeable using a solar panel and are predicted to have a useful life of approximately five years before replacement. The system can operate properly for up to three months without sunlight.

One example includes a temperature sensor configured to draw a current of approximately 20 uA from the nodes. A node is a transmitter, and can connect four sensors into it. A node transmits sensor data from the sensor(s) to the control panel.

In one example, a gateway server draws 4 W power from a metered line service operating at 110 VAC. The gateway server is located inside a control panel. It is just one gateway server. It is connected to the base station receiver using USB communication, and connected to a router using Ethernet communication. It operates as a web server using a router to communicate to the internet, allowing a user to log in to monitor and control operations in an oil field.

In one example, a base station is configured to draw current of approximately 30 mA from the gateway through a USB port. The base station can be located inside the control panel and connected using USB communication. The gateway server controls the base station supplying power to it.

The data from oil field sensors sense, then send to the transmitter nodes. The transmitter nodes send the data from sensors to the base station receiver periodically (such as at every 15 minutes). The gateway receives data in XML format. A web-accessible site reads the data periodically using XML and displays the data.

In one example, the sensors communicate using a wireless protocol to send information. The sensors meant are the transmitter nodes. One transmitter node can communicate to the base station within about 1000 ft, if the node is 2000 ft away, 2000 ft one can send the data to the 1000 ft one, and the 1000 ft one can send the data from the 2000 ft one to the base station receiver. The information is conveyed by a mesh or linked series of transceivers. In one example, wireless communication is used to link a sensor to a base station.

In one example, wireless communication includes using ZigBee protocol. ZigBee refers to low-power digital radio according to the IEEE 802.15.4-2003 standard for wireless personal area networks (WPANs). ZigBee can be used to establish a mesh network.

In other examples, wireless communication is conducted using Bluetooth or other wireless protocol.

In one example, the wireless transmitter uses direct-sequence spread spectrum coding and transmits using a radio frequency of 2.4 GHz.

In one example, the sensors and transmitter nodes are small. The sensors can be easily removed from and installed into the nodes. The nodes can be easily removed from the oil field. As used herein, portability refers to easily removed from, and installed into.

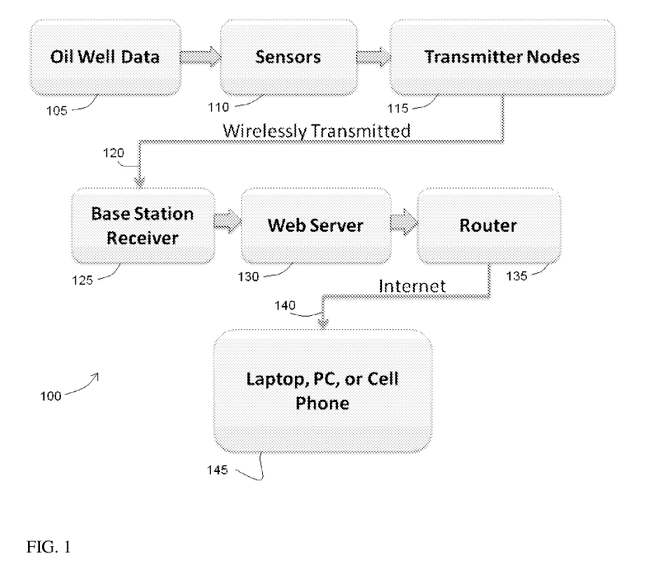

FIG. 1 illustrates system 100 according to one example. Oil well data 105 represents a parameter that is monitored or measured by sensor 110. For example, oil well data 105 can represent a temperature of a process or a valve position. Sensor 110 is configured to generate a signal corresponding to the temperature, valve position, or other parameter. The signal generated by sensor 110 is communicated by a wired link to transmitter node 115. Transmitter node 115, in one example, includes a receiver and can be described as a transceiver node. Transmitter node 115 is configured to convert the signal from sensor 110 to a wireless signal.

In one example, 1-4 sensors can be used. The sensors can be of different types. The shorter range the better. The node can receive wired sensor data. The node is powered by 3 AA rechargeable batteries. The batteries are recharged by a solar panel. The batteries can last up to 5 years. A node can be remotely configured. The wireless signal is communicated, using link 120, to base station receiver 125. The base station receiver can communicate wirelessly to multiple transmitter nodes. The range is approximately 1000 feet. The base station is powered by the gateway web server. In one example, the USB cable is 6 feet long.

Base station receiver 125 is further coupled to web server 130. The coupling can include a wired coupling (such as an Ethernet line or other network) or a wireless link.

Web server 130, in one example, is coupled to router 135 by a wired or wireless coupling. Router 135 can be configured to connect with a wide area network (such as the internet) using a wired or wireless link 140. Link 140 can include a wired (such as an Ethernet line or other network) or a wireless link.

User device 145 can include a laptop computer, a personal computer (desktop), a handheld device such as a cellular telephone or other such device to allow a user to visually or audibly monitor performance of an oil production facility based on measured parameters provided by a wireless sensor.

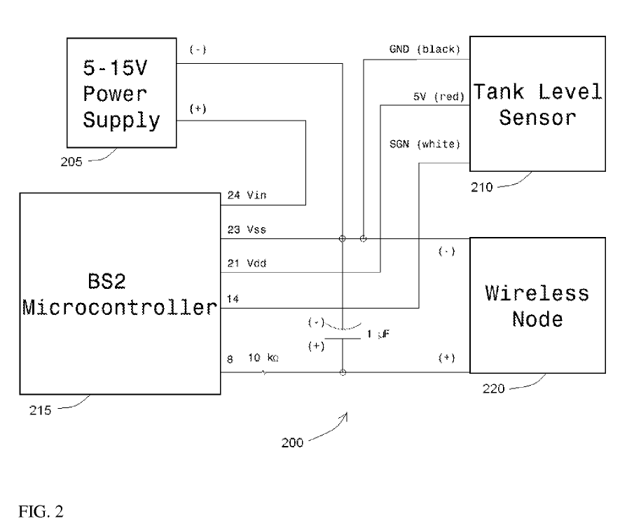

FIG. 2 illustrates module 200 according to one example. In the example shown, module 200 includes power supply 205, sensor 210, microcontroller 215 and node 220. Module 200 is configured for installation at a sensor site which, according to one example, includes a component or system of an oil production facility.

Power supply 205, in one example, includes at least one battery (such as ten AA rechargeable batteries) and a solar panel. The battery can include a rechargeable cell. The solar panel can include any of a variety of different types of solar cells, including a panel having dimensions of 6×6 in. and configured to provide 10V 150 mA. Power supply 205, in the example shown, provides a DC voltage between 5 and 15 volts.

Sensor 210, in the example shown, includes a tank level sensor, however, other types of sensors are also contemplated. For example, the tank level sensor can be configured to provide an output signal corresponding to a fluid level within a tank and generated based on an electrical resistance, capacitance, inductance, or based on ultrasonic, optical, or mass properties, among others.

Microcontroller 215 is coupled to power supply 205, sensor 210, and node 220. Microcontroller 215 is configured to control operation of sensor 210 and node 220. Microcontroller 215, in one example, includes a memory for storing data and executable instructions.

Node 220 is configured for wireless communication and in one example, is configured to communicate using ZigBee.

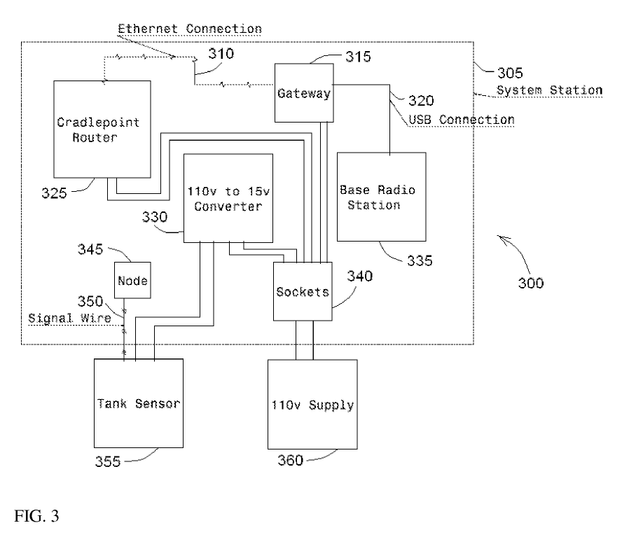

FIG. 3 includes a block diagram showing system station 305. The gateway communicates with the router using Ethernet communication.

System station 305 includes router 325 coupled by Ethernet connection 310 with gateway 315. Gateway 315 is coupled by USB connection 320 to base radio station 335 (also referred to elsewhere in this document as a base station receiver or as a base station). Gateway 315 and router 325 are coupled to sockets 340. The socket takes 110V power line and supplies to the gateway server, the router, 110v to 15v adapter which supplies power to the tank sensor. System station 305 includes converter 330 and node 345.

Converter 330 is configured to convert metered line service at 110VAC to 15VDC, and in various examples, includes a rectifier and a transformer. Node 345 is coupled by signal wire 350 to tank sensor 355 located external to system station 305. Also located external to system station 305 is supply 360. Supply 360, in the example shown, provides 110VAC.

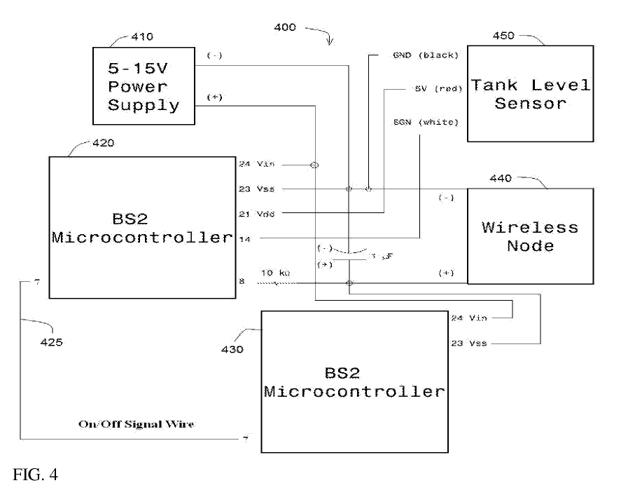

One example includes a tank sensor having two controllers, as shown in FIG. 4. FIG. 4 illustrates device 400. In this example, device 400 includes sensor 450. Controllers 420 and 430 are coupled by an on/off line 425 used to manage the operations of the separate controllers. The example includes one controller 420 coupled to the wireless node 440 and configured to conduct wireless communications. Power supply 410 can include a battery, a solar cell, a fuel cell or other storage device operable independent of a metered line service.

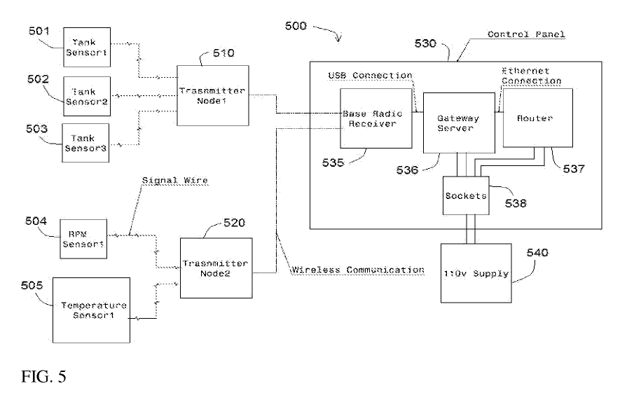

The system station is the control panel. In one example, the tank sensor is powered from a 110v power supply. In one example, a timer controller is coupled to the tank sensor to turn on the ultrasonic sensor every hour in order to save energy. The tank sensor can be powered using ten batteries and a solar panel. FIG. 5 illustrates a block diagram of an example of system 500. In this example, a plurality of tank sensors (501, 502, and 503) are coupled to a single transmitter node 510. In addition, a shaft speed sensor (RPM), 504 and a temperature sensor 505 are coupled to another single transmitter node 520. The two transmitter nodes (510 and 520) are wirelessly coupled to control panel 530. The control panel 530 includes a base radio receiver 535, a gateway server 536, a router 537, and sockets 537. Metered line service is provided to control panel 530 by supply 540.

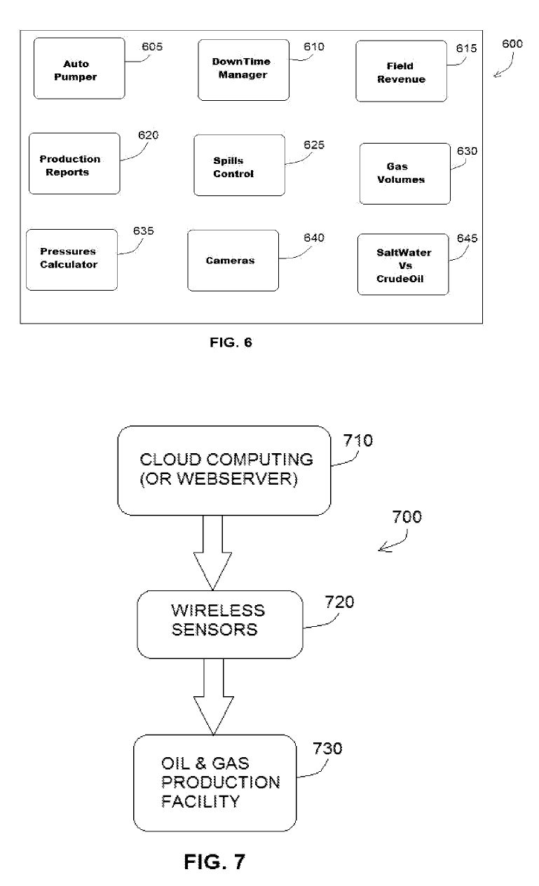

FIG. 6 illustrates a block diagram of server 600 according to one example. Server 600 is comparable to web server 130 as describe elsewhere in this document.

In one example, server 600, includes a web-accessible (or online) database. Web-accessible server 600, also known as an online database or a cloud computing platform, provides access to oil and gas production information. In one example, the information is stored in any of a variety of extensible markup language (also known as XML) formats. The XML format is suited for encoding documents and accommodates a variety of data including different field activity such as tank level, pump current, pressure, or flow rate from the production facility. The information is stored in an online database (web server) and can be accessed or manipulated by a web application. The web application can be used to perform calculations to analyze the data. For example, a web application can be used to calculate barrels of oil produced, oil field downtime, salt water ratios, or other parameters. FIG. 6 illustrates a variety of data types that can be encoded using XML or that can be generated using a web application implemented using server 600. For example, the data can correspond to an auto pumper (at 605); a downtime manager (at 610); a field revenue (at 615); a production report (at 620); spill control (at 625); gas volume (at 630); pressure calculations (at 635); cameras (at 640); and a ratio of saltwater to crude oil (at 645). The foregoing are examples, and it is understood that other types of data and other applications are also contemplated.

FIG. 7 illustrates a diagram of process flow 700, according to one example. Process flow 700, at 710, includes a cloud computer (or web server). Cloud computing provides selected business applications online. The applications are delivered over the internet using a web browser implemented on a computer. The software and data for the application are stored on servers that may be geographically distributed.

In one example of the present subject matter, the business application can include a software program to monitor a component or parameter of an oil field production facility. For instance, a performance parameter for a pump jack in a remote oil field can be monitored using a web-accessible business application. The data from the pump jack is wirelessly transmitted and processed using a web-accessible application.

At 720, a wireless sensor provides the raw data. The wireless sensor is coupled to equipment of an oil field production facility, such as a pump jack, an oil line, a tank, or other equipment.

At 730, the processed data derived from the wireless sensor is analyzed and provided to an oil and gas production facility. The data can be correlated with annual production quotas, safety information, or information from other data sources.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A system comprising:
a sensor having a sensor output corresponding to a measured parameter corresponding to an oil production facility;
a transmitter coupled to the sensor output and configured to provide a wireless signal corresponding to the sensor output;
a receiver configured to receive the wireless signal and provide output data corresponding to the wireless signal;
an interface configured to receive the output data and configured to communicate using a network; and
a user device coupled to the network and configured to provide user-perceivable information corresponding to the output data.

2. The system of claim 1 wherein the sensor includes at least one of a flow rate sensor, a level sensor, an electronic nose, a chemical sensor, a temperature sensor, a pressure sensor, and a position sensor.

3. The system of claim 1 wherein the transmitter includes a microcontroller.

4. The system of claim 1 wherein the transmitter includes a battery power supply.

5. The system of claim 1 wherein the transmitter includes a solar cell power supply.

6. The system of claim 1 wherein the transmitter operates on a radio frequency band.

7. The system of claim 1 wherein the interface includes at least one of a server and a router.

8. The system of claim 1 wherein the user device includes at least one of a desktop computer, a laptop computer, and a cellular telephone.

9. A method comprising:
detecting a parameter corresponding to an oil production facility;
generating an electrical output based on the parameter;
wirelessly transmitting a signal corresponding to the electrical output;
receiving the signal;
transforming the received signal to digital data; and
communicating the digital data using a network.

10. The method of claim 9 wherein detecting the parameter includes detecting at least one of a flow rate, a level, a chemical, a temperature, a pressure, and a position.

11. The method of claim 9 wherein wirelessly transmitting includes transmitting using a radio frequency.

12. The method of claim 9 wherein wirelessly transmitting includes transmitting using a digital communication protocol.

13. The method of claim 9 wherein transmitting includes generating electric power using a solar cell.

14. The method of claim 9 wherein communicating the digital data using a network includes communicating using at least one of a server and a router.
